(19) United States
(12) Patent Application Publication
(10) Pub. No.: US 2014/0044904 A1
(43) Pub. Date: Feb. 13, 2014

(54) DEEP GLOSS CONTAINERS, AND PREFORMS FOR MAKING THEM

(71) Applicant: The Procter & Gamble Company, Cincinnati, OH (US)

(72) Inventors: Gian Armand Juliana DE BELDER, SCHELLE (BE); Christian Friedrich Gerhard GERLACH, ST. GILLES (BRUSSELS) (BE); Ping WANG, BEIJING (CN)

(73) Assignee: The Procter & Gamble Company, Cincinnati, OH (US)

(21) Appl. No.: 13/958,795

(22) Filed: Aug. 5, 2013

(30) Foreign Application Priority Data
Aug. 8, 2012 (WO) CN2012/079833

(51) Int. Cl. B29B 11/16

(52) U.S. Cl. CPC B29B 11/16
USPC 428/35.7; 428/483; 428/516; 428/323

(57) ABSTRACT

The present invention relates to a preform (1), and resultant container (10), having at least a first layer (2) and a second layer (3) which forms an outer layer, relative to the first layer (2). The inner layer (2) comprises a pearlescent agent, while the outer layer (3) comprises a colorant, such that the resultant container (10) has a high gloss finish, is easy to manufacture, and does not result in colorant leaching into the contained fluid.

### FIELD OF THE INVENTION

Preforms for making containers having a rich glossy appearance, and containers made therefrom.

### BACKGROUND OF THE INVENTION

The days when packaging was intended just to store product are long gone. Presently, packaging is used to also ensure product stands out on the market shelf, and to signify the quality, and luxury of the product contained therein.

Containers having a deep colour and a glossy impression give a particularly strong sensation of luxury and quality. The glossiness of a material is affected by such factors as the amount of light that is reflected, instead of transmitted through, or absorbed by, the material and surface finish. Materials having smooth surfaces appear glossier than rough surfaces. Highly polished, smooth surfaces reflect a high percentage of light hitting the surface thereof (specular reflection). Rough surfaces cause light to be deflected at a wide array of angles (diffuse reflection), reducing the glossiness.

Traditionally, coloured glossy containers have been made by adding a pearlescent agent and a colorant into the polymeric material used to form a single layer bottle. However, the pearlescent agent results in a rough surface and a level of glossiness that is less than might otherwise have been achieved. This is especially the case for opaque bottles comprising high levels of pearlescent agent or other particulate materials.

Attempts to improve glossiness, by adding either more pearlescent agent or more colorant, have had limited success. This is because increasing the colorant level, in an effort to achieve a richer colour, results in more of the light reflecting off the pearlescent agent being absorbed.

Increasing the add-on level of the pearlescent agent increases the surface roughness, and hence reduces the glossiness level. The pearlescent agent, and any metallic particles that may be present, such as aluminium and bronze flakes, also interact with infra-red (IR) heating, which is typically used to preheat the preform prior to blowing into the final container shape. At high loadings of pearlescent agent and metal particles, the preform cannot be effectively preheated. This is because the particulate material reflects much of the IR radiation, and prevents the IR radiation from being absorbed by the plastic material. The result is non-uniform heating of the preform, leading to low quality bottles, unacceptably low blowing speeds, or high scrap rates.

A further challenge has been to make a high gloss bottle having a lower environmental impact. Biodegradable and renewable materials have, in general, resulted in containers having a less transparent outer layer and poorer surface finish.

Several attempts have been made to get around at least some of these constraints. For instance, JP 06-239350 discloses a three layer metallic effect glossy bottle, having a dark coloured inner-layer, underneath an intermediate layer comprising iridescent mica, and a transparent outer layer. In these bottles, improved glossiness is achieved by matching the colour of the inner layer and the colour of the iridescent particles of the intermediate layer. However, to achieve a dark inner-layer, a high colorant loading is needed, resulting in a dark bottle and an increased tendency for the colorant ingredients to leach into the product contained within the container.

As such, a need remains for a preform and container having a rich glossy colour, which is easy to manufacture, and does not result in leaching of the colorant ingredients from the container into the product.

Typically, the production of preforms and containers, having a metallic effect, has required an aesthetics “master-batch” with a blend of aesthetics ingredients, having just the right amount of the necessary dye, mica and metal flakes. A need remains for preforms and containers having a metallic effect, while not requiring complex blends of aesthetics ingredients such as metallic flakes, and which are easier to process.

### SUMMARY OF THE INVENTION

The present invention relates to a preform (1) comprising a first layer (2) and a second layer (3), with the second layer (3) being an outer layer relative to the first layer (2), wherein: the first layer (2) comprises a pearlescent agent; and second layer (3) is substantially transparent and comprises a colorant.

The present invention also relates to containers (10) formed from such preforms (1).

### BRIEF DESCRIPTION OF THE DRAWINGS

FIG. 1 illustrates a cross-section of an embodiment of the preform (1), having an open end (6), side walls (7) and an opposing end (8), and comprising two layers: the first layer (2) and the second layer (3).

FIG. 2 illustrates a cross-section of an embodiment of the preform (1), comprising three layers: the first layer (2), the second layer (3), and an additional layer (5) on the inside of the first layer (2).

FIG. 3 illustrates a cross-section of a container (10), having an open end (60), side walls (70) and an opposing end (80), the container having a container first layer (20) and a container second layer (30).

### DETAILED DESCRIPTION OF THE INVENTION

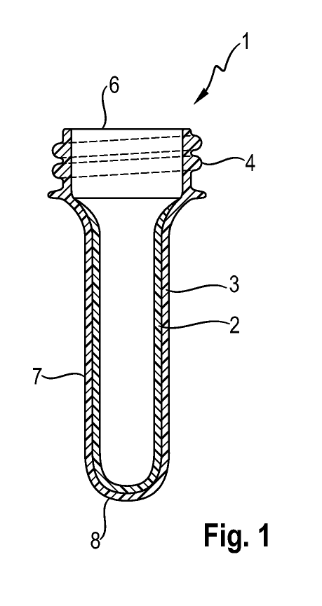

A “preform” is an article that has been subjected to preliminary, usually incomplete, shaping or moulding, and is normally further processed to form a final container. The preform (1) is usually approximately “test-tube” shaped, as exemplified in FIG. 1.

The term “container” as used herein refers to any hollow article, usually obtained by blow-moulding. The containers of the present invention are suitable for use as a container for any kind of matter, such as liquids, solids or semi-solids. The term container does not imply a particular intended use for the article. For example, the term “container” as used herein encompasses articles destined to contain cosmetic products (e.g. shampoos, creams, etc), edible products (e.g. milk, soft drink, condiments, etc), chemicals, etc. The preforms and containers of the present invention can be practical for laundry, household care, and personal care bottles.

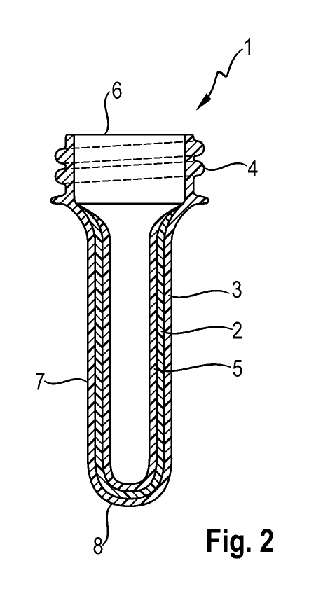

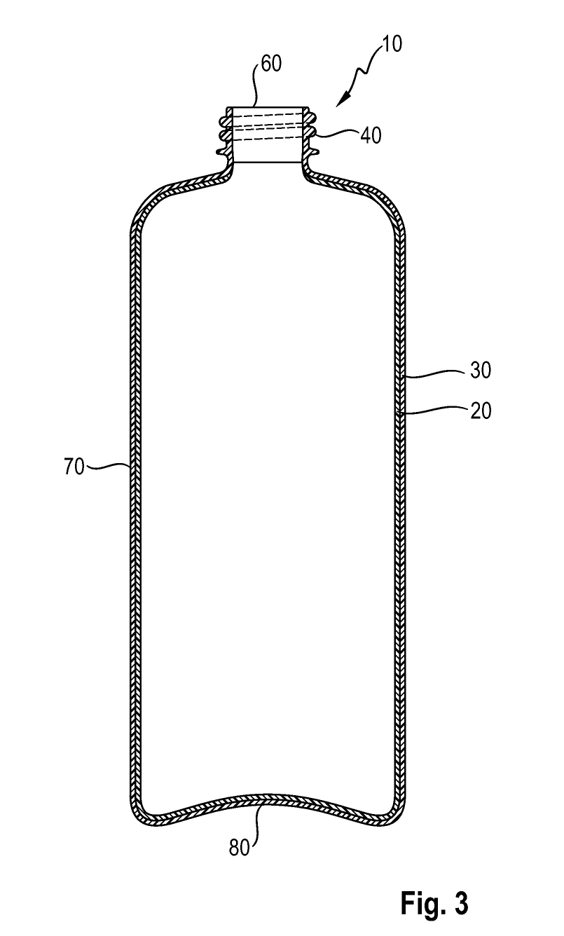

It has been discovered that the preforms of the present invention, as exemplified in FIG. 1 and FIG. 2, result in a container having an exceptional glossy effect. Furthermore, by adding the colorant to a layer, over the layer comprising the pearlescent agent, it is possible to provide a wide array of coloured gloss and metallic effects without requiring complex master-batches. In addition, by placing the pearlescent agent in a separate, inner layer, the same deep gloss effect can be achieved with a thinner layer comprising the pearlescent agent. This results in a preform (1) that is easier to reheat using infra-red energy, for subsequent blow moulding to form the container, as exemplified in FIG. 3. Furthermore, it has been discovered that the inner layer, comprising the pearlescent agent, increases the overall opacity of the bottle, without affecting the reheating of the outer layers, while forming an effective barrier layer for preventing colorant leaching into the product.

As defined herein, “essentially free of” a component means that no amount of that component is deliberately incorporated into the layer, preform, or container.

All percentages, ratios and proportions used herein are by weight percent of the preform or container, unless otherwise specified. All average values are calculated “by weight” of the preform or container, unless otherwise expressly indicated.

All measurements are performed at 25° C. unless otherwise specified.

### Preform:

The present invention relates to preforms (1) for making multilayer containers (10), such as bottles.

The preform (1) comprises at least a first layer (2) and a second layer (3). The preform (1) can be made by any suitable process, such as co-injection, or over-moulding.

Co-injection moulding is a process whereby the material of an outer layer is typically injected first into the mould cavity, and is immediately followed by the material of an inner layer. As the material of the outer layer flows into the cavity, the material next to the cavity walls freezes and material flows down a centre channel. When the material of the inner layer enters, it displaces the material of the outer layer in the centre of the channel by pushing the material of the outer layer ahead. As it flows ahead it continues to freeze on the walls producing the outer layer. Over-moulding is an injection moulding process whereby one layer is moulded onto a second layer.

Without being bound by theory, over-moulding is preferred, since it is thought to provide a bottle having an improved surface finish, and hence gloss. Examples of co-injection processes are given in EP 1 681 239, and US 2005/0170114. Examples of over-moulding are given in EP 1 987 936, and WO 2008/125709. The aforementioned references also describe suitable processes for stretch blow moulding of the preform (1) into a container comprising the first layer (2) and second layer (3). However, any suitable means of forming the container can be used.

The preform (1) comprises at least the first layer (2) and second layer (3), with the first layer (2) forming the inner layer of the two layers. For a preform (1) comprising additional layers, the first layer (2) and second layer (3) are preferably the two outermost layers. Even more preferably, the preform (1), and hence the subsequent container, comprises only two layers.

The first layer (2) and second layer (3) typically comprise any suitable thermoplastic resin. A thermoplastic resin is material that softens when heated and hardens again when cooled. The thermoplastic resin can be selected from hydrophobic thermoplastic resins, particularly polyolefin resins, and mixtures thereof. Suitable polyolefin resins include, among others, high density, medium density or low density polyethylene; copolymers of polyethylene with vinyl acetate, acrylic acid esters, or [alpha]-olefins such as butene, hexene, 4-methyl-1-pentene; polypropylene homopolymer; polypropylene grafted with ethylene; copolymers of propylene with [alpha]-olefins such as ethylene, hexene and 4-methyl-1-pentene; poly-1-butene, poly-4-methyl-1-pentene; modified polyolefins comprising above-mentioned polyolefins modified with maleic anhydride; and mixtures thereof.

The thermoplastic resin may further include polyamides, poly-esteramides, saturated polyesters and copolymers thereof, polystyrene, polyvinyl chloride, polyacrylonitrile, polyvinylidene chloride, poly-urethanes, polyvinyl acetate, polyacetals; polycarbonates; and mixtures thereof.

The first layer (2) can comprise a thermoplastic resin selected from the group consisting of: polyethylene (PE), polypropylene (PP), and polyethylene terephthalate (PET), and mixtures thereof. The second layer (2) can comprise a thermoplastic resin selected from the group consisting of: polyethylene (PE), polypropylene (PP), and polyethylene terephthalate (PET), and mixtures thereof. More preferably the first layer (2) and the second layer (3) both comprise a thermoplastic resin selected from the group consisting of: polyethylene (PE), polypropylene (PP), and polyethylene terephthalate (PET), and mixtures thereof. Even more preferably, the first layer (2) and the second layer (3) both comprise the same thermoplastic resin, selected from the group consisting of: polyethylene (PE), polypropylene (PP), and polyethylene terephthalate (PET), and mixtures thereof.

The first layer (2), second layer (3), and combinations thereof, of the preform (1), may comprise a renewable thermoplastic resin. As such, the resultant container may comprise a renewable thermoplastic resin. Thermoplastic resins at least partially, preferably fully, comprise a renewable material. Renewable materials are typically biobased, being derived from biomass sources such as sugars, vegetable fats and oils, corn starch, and pea starch. The renewable thermoplastic resin can be selected from the group consisting of: a high density polyethylene (HDPE) having a biobased content of at least 95%; polyethylene terephthalate (PET), or a polyester of furan dicarboxylic acid, each having a biobased content of at least 90%; a polypropylene (PP) having a biobased content of at least 90%; and combinations thereof.

Preferably, all layers of the preform (1), which comprise a thermoplastic resin, comprise a renewable thermoplastic resin. The renewable thermoplastic resin can be at a level of at least 10% by weight of the layer. The preform (1) can comprise at least 10%, by weight of the preform, of renewable thermoplastic resin. Preferably, the preform (1) comprises at least 25%, more preferably 50%, even more preferably 75%, most preferably at least 95% by weight of the preform (1). Since the use of such renewable materials can result in improved clarity and surface finish compared to other biodegradable resins and renewable materials, the result can be a bottle having an improved environmental impact, while also delivering high gloss aesthetics.

The renewable thermoplastic resin can comprise a high density polyethylene (HDPE) having a biobased content of at least 95%, by weight. Such renewable thermoplastic resins may also include a polymer selected from the group consisting of post-consumer recycled polyethylene (PCR-PE), post-industrial recycled polyethylene (PIR-PE), regrind polyethylene, and mixtures thereof.

Alternatively, or additionally, the renewable thermoplastic resin may comprise: polyethylene terephthalate (PET), or a polyester of furan dicarboxylic acid, each having a biobased content of at least 90%, by weight. The renewable thermoplastic resin, comprising the PET, may further comprise a polymer selected from the group consisting of: post-consumer recycled polyethylene terephthalate (PCR-PET), post-industrial recycled polyethylene terephthalate (PIR-PET), regrind polyethylene terephthalate, and mixtures thereof. The renewable thermoplastic resin comprising a polyester of furan dicarboxylic acid, may also comprise a polymer selected from the group consisting of a post-consumer recycled polyester of furan dicarboxylic acid, a post-industrial recycled polyester of furan dicarboxylic acid, a regrind polyester of furan dicarboxylic acid, and mixtures thereof.

Alternatively, or additionally, the renewable thermoplastic resin may comprise a polypropylene (PP) having a biobased content of at least 90%, by weight. The renewable thermoplastic resin, comprising the PP, may further comprise a polymer selected from the group consisting of: post-consumer recycled polypropylene (PCR-PP), post-industrial recycled polypropylene (PIR-PP), regrind polypropylene, and a mixture thereof.

Further details on suitable renewable materials can be found in US 2011/0120902 A1.

One or more layers may also comprise a number of suitable additives. For instance, an additive can be added to improve the mechanical strength of the layer, reduce gas permeability, or to improve adhesion to the adjacent layer.

### First Layer of the Preform

The first layer (2) of the preform (1) can have a thickness of 1 mm to 3 mm, preferably 1.2 mm to 2.4 mm, more preferably 1.6 mm to 2 mm, as measured at a position half way between the open end and the opposing end.

The first layer (2) of the preform (1) can be substantially opaque, for instance, having a transmittance of less that 20%, preferably less than 15%, more preferably less than 10%. Even more preferably, the first layer (2) is fully opaque, for instance, having a transmittance of less that 10%, preferably less than 5%, more preferably less than 1%. The transmittance of the first layer (2) is assessed by delaminating the perform (1), by any suitable means, and measuring the transmittance of the delaminated first layer (2). The transmittance is measured by ISO 2471 using a Perkin Elmer Lambda 35 with integrated sphere. The first layer (2) can be made substantially or fully opaque through the use of the pearlescent agent, or by adding a combination of the pearlescent agent and an opacifier, as is known by those skilled in the art.

To achieve a bright glossy effect, it is preferred that the first layer (2) comprises limited amounts of colorant, such as a dye or pigment. Dyes can dissolve in a thermoplastic resin, for instance, that used in the first layer (2), while pigments are particulate materials which cannot dissolve in a thermoplastic resin. Preferably, the colorant level is added such that the first layer (2) has a lightness, L, of 35 or more, preferably 45 or more, more preferably 50 or more. The first layer (2) can comprise negligible amounts of colorant, causing no visible change in the colour of the first layer (2). Most preferably, the first layer (2) is free from colorant. The pearlescent agent, used in the present invention, is not considered to be a colorant.

### Pearlescent Agent:

Pearlescent agents are particulate materials which provide a pearl-like lustre, while imparting no colour, except through iridescence.

The first layer (2) preferably comprises from 0.01 to 10%, preferably from 0.1 to 5%, more preferably from 0.15 to 1.5% by weight of the pearlescent agent. The pearlescent effect develops through interference between light rays reflecting at specular angles from the top and bottom surfaces of an outer layer of the pearlescent agent. The agents are thought to lose colour intensity as viewing angle shifts to non-specular angles, resulting in the pearlescent appearance.

While suitable pearlescent agents can be organic or inorganic, inorganic pearlescent materials are preferred since they are believed to be less degraded during making of the preform (1) and container. Suitable inorganic pearlescent agents include: mica, metal oxide coated mica, silica coated mica, bismuth oxychloride coated mica, bismuth oxychloride, glass, metal oxide coated glass, and mixtures thereof. Preferably, the pearlescent agent is selected from the group consisting of: mica, coated mica, titanium dioxide, and mixtures thereof. More preferably, the inorganic pearlescent agent is mica, optionally with a coating layer.

The coating layer can comprise a metal oxide. More preferably, the coating layer consists of a metal oxide. The metal oxides can be selected from the group consisting of rutile, titanium dioxide, ferric oxide, tin oxide, alumina and mixtures thereof. The coating layer can be formed by calcining mica coated with a metal oxide at above 700° C. The heat creates an inert layer that is insoluble in thermoplastic resins, has a stable colour, and withstands the thermal stress of subsequent processing.

Suitable inorganic pearlescent agents are available from Merck under the tradenames IRIODIN, BIRON, XIRONA, TIMIRON COLORONA, DICHRONA, CANDURIN and RONASTAR. Other commercially available inorganic pearlescent agents are available from BASF under tradenames BIJU, BI-LITE, CHROMA-LITE, PEARL-GLO, MEARLITE and ECKART under the tradenames PRESTIGE SOFT SILVER AND PRESTIGE SILK SILVER STAR.

There is no particular limitation to the shape of the pearlescent agent used in the invention but, particles of the pearlescent agent preferably have a weight average aspect ratio of at least 10 (see test methods).

Any suitable particle size distribution for the pearlescent agent can be used. The pearlescent agent of the first layer (2) preferably has a weight average flake diameter of from 1 to 200 microns (see test methods).

A smaller weight average flake diameter is thought to lead to less coverage, and hence lower opacity and higher translucency for the same weight percent addition of pearlescent agent. A coarser weight average flake diameter is thought to lead to more brightness, and an increased sparkle effect.

Hence, for more translucent bottles, a weight average flake diameter of from 1 to 20 microns, preferably from 5 to 15 microns, most preferably from 8 to 12 microns is preferred. In contrast, for bright, sparkly bottles, a weight average flake diameter of from 45 to 200 microns, preferably from 50 to 100 microns, more preferably from 55 to 65 microns is preferred. For a balance of opaqueness and brightness, a weight average flake diameter of from 20 to 45, more preferably from 22.5 to 40, most preferably from 25 to 35 microns is preferred.

Alternatively, a blend of different particle size distributions can be used to achieve different aesthetics.

### Second Layer of the Preform

The second layer (3) can have a thickness of from 1 mm to 3 mm, preferably 1.5 mm to 2.5 mm, more preferably 1.8 mm to 2.2 mm, as measured on the side wall (7), at a position half way between the open end (6) and the opposing end (8).

The second layer (3) comprises a colorant. Any suitable colorant, depending on the desired colour and need, can be used. Any suitable level of colorant can be used. The level of colorant in the second layer (3) can be at a level of from 0.001% to 10%, preferably from 0.01% to 2%, more preferably from 0.1% to 0.4% by weight of colorant. The colorant can be selected from the group consisting of: dyes, pigments, and mixtures thereof. Dyes, which dissolve in the thermoplastic resin of the second layer (3), are preferred over pigments. Without being bound by theory, it is believed that dyes can result in less loss of transparency of the second layer (3), as compared to pigments. For the same reason, and also for improved surface finish, the second layer (3) preferably comprises less than 1.5%, more preferably less than 0.15% by weight of a pearlescent agent. Most preferably, the second layer (3) is substantially free of pearlescent agent. That is, no pearlescent agent is intentionally added.

The second layer (3) is substantially transparent. As such, the second layer (3) can have a transmittance of from 20% to 100%, preferably from 50% to 100%, more preferable from 70% to 100%. The transmittance of the second layer (3) is assessed by delaminating the preform (1) at a position on the side wall (7), half way between the open end (6) and the container opposing end (8), by any suitable means, and measuring the transmittance of the delaminated second layer (3). The transmittance is measured by ISO 2471 using a Perkin Elmer Lambda 35 with integrated sphere.

Different metallic effects can be achieved with preforms (1) of the present invention, and the resultant containers, through a suitable choice of pearlescent agent of the first layer (2), and colorant of the second layer (3), even when the preform (1) is substantially free of metallic particles, thus comprising insufficient metallic particles to change the aesthetics of the resultant container. Preferably, the preform (1) is free of metallic particles. For instance, a gold-effect or bronze-effect container can be achieved from a preform (1), and container thereof, when the colorant of the second layer (3) has a yellow or brown colour, even when the preform (1) comprises insufficient metallic particles to visibly change the aesthetics of the resultant container, or the preform (1) comprises no metallic particles. Whether such a metallic-effect preform, and resultant container, is more lustrous or more sparkly can be tuned through the selection of weight average flake diameter of the pearlescent agent. Hence, for a metallic effect preform (1), and resultant container thereof, the pearlescent agent preferably has a weight average flake diameter of from 45 to 200 microns, more preferably from 50 to 100 microns, most preferably from 55 to 65 microns.

### Container:

The container of the present invention, as exemplified in FIG. 3, can be formed from the aforementioned performs, or by any other suitable means. The container (10) comprises at least a container first layer (20) and a container second layer (30). The container first layer (20) comprises a pearlescent layer, and the container second layer (30) comprises a colorant. The colorant can be selected from the group consisting of: dyes, pigments, and mixtures thereof. The colorant is preferably a dye. The container (10) of the present invention preferably has a gloss level, as measured by ISO 2813, of from 70 to 130, more preferably from 75 to 120, most preferably from 80 to 130 GU (Gloss Units), as measured using an Erichson Picogloss 503 measurement device with a 20° measurement angle, calibrated according to the manual provided.

By adding a pearlescent agent in the container first layer (20), while adding a colorant to the container second layer (30), the vividness of the colour of the container (10) can be improved. With such a container construction, it is believed that the pearlescent agent of the container first layer (20) does not interfere with the colour of the container, while still providing a pearlescent effect. Preferably, the colorant level is added at a level such that the container (10) has a lightness, L, of at least 25, preferably at least 35, more preferably at least 40, when measured at the outer surface of container.

The container first layer (2) can have a thickness of 0.05 mm to 0.30 mm, preferably 0.10 mm to 0.25 mm, more preferably 0.14 mm to 0.20 mm, as measured at a position on the container side wall (70), half way between the container open end (60) and the container opposing end (80).

The container first layer (20) can be substantially opaque, for instance, having a transmittance of less that 20%, preferably less than 15%, more preferably less than 10%. More preferably, the container first layer (20) is fully opaque, for instance, having a transmittance of less that 10%, preferably less than 5%, more preferably less than 1%. The transmittance of the container first layer (20) is assessed by delaminating the container (10) at a position on the side wall (70), half way between the open end (60) and the opposing end (80), by any suitable means, and measuring the transmittance of the delaminated container first layer (20). The container first layer (20) can be made substantially or fully opaque through the use of the pearlescent agent, or by adding a combination of the pearlescent agent and an opacifier, as known to those skilled in the art.

The container second layer (30) can be substantially transparent, having a transmittance of from 20% to 100%, preferably from 50% to 100%, more preferable from 70% to 100%. The transmittance of the container second layer (30) is assessed by delaminating the container (10) at a position on the container side wall (70), half way between the container open end (60) and the container opposing end (80), by any suitable means, and measuring the transmittance of the delaminated container second layer (30).

The container (10) can be substantially or fully opaque, having a transmittance of less than 15% preferably less than 10%, more preferably less than 5%. More preferably, the container (10) is fully opaque, for instance, having a transmittance of less than 5%, preferably less than 1%. The transmittance of the container (10) is assessed at a position on the container side wall (70), half way between the container open end (60) and the container opposing end (80).

The transmittance is measured by ISO 2471 using a Perkin Elmer Lambda 35 with integrated sphere.

The container second layer (30) can have a thickness of from 0.05 mm to 0.30 mm, preferably 0.10 mm to 0.27 mm, more preferably 0.15 mm to 0.25 mm, as measured at a position on the container side wall (70), half way between the open end (60) and the opposing end (80).

Different metallic effects can be achieved with the containers (10) of the present invention, through a suitable choice of pearlescent agent of the container first layer (20), and colorant of the container second layer (30), even when the container (10) contains either no metallic particles, or insufficient metallic particles to alter the aesthetics of the container. For instance, a gold-effect or bronze-effect container can be achieved from a container (10), when the colorant of the container second layer (30) has a yellow or brown colour, even when the container (10) is substantially free of metallic particles. When the container (10) is substantially free of metallic particles, the container (10) typically comprises insufficient metallic particles to visibly change the aesthetics of the container (10). Preferably, the container (10) is free of metallic particles. Whether such a metallic-effect container is more lustrous or more sparkly, can be tuned through the selection of weight average flake diameter of the pearlescent agent. Hence, for a metallic effect container (10), the pearlescent agent of the container first layer (20) preferably has a weight average flake diameter of from 45 to 200 microns, more preferably from 50 to 100 microns, most preferably from 55 to 65 microns.

The container (10) can be made by blow-moulding a preform (1) of the present invention. The various methods of blow moulding are well known. Injection blow-moulding (IBM) and its variant, injection stretch blow-moulding (ISBM), are commonly used to manufacture high quality hollow articles, such as bottles, on an industrial scale.

In the first step of both IBM and ISBM processes, a preform (1) is made, typically by an injection-moulding process, as described earlier. The preform (1) is subsequently blow-moulded or stretch blow-moulded to form a container, as exemplified in FIG. 3. Usually the neck (4) of the preform remains substantially unchanged during the blow-moulding process while the body of the preform will expand considerably. The preform (1) can be blow moulded, or stretch blow moulded, immediately after forming. Alternatively, the preform (1) can be stored, or transported to a different location, before later being reheated and blown into the final container.

In the injection “blow-moulding process”, the preform (1) is reheated, if necessary, before being transferred to a blow-mould having the shape of the desired hollow container. The preform (1) is held by the neck (4) and air passing through a valve inflates the hot preform (1), which is typically at a temperature of from 85° C. to 115° C. The preform (1) expands and takes the form of the blow-mould. Typically, little or no axial stretching takes place. After the desired container has sufficiently cooled to be handled, it is removed from the blow-mould and is ready for use. More information on injection blow-moulding processes can be obtained from general textbooks, for example “The Wiley Encyclopaedia of Packaging Technology”, Second Edition (1997), published by Wiley-Interscience Publication (in particular see page 87).

In the injection “stretch blow moulding” process (sometimes referred to as biaxial-orientation blow-moulding), the preform (1) is reheated to a temperature warm enough to allow the preform (1) to be inflated so that a biaxial molecular alignment in the sidewall of the resulting blow-moulded container is achieved. With the preform (1) held at the neck (4), air pressure, and usually a stretch rod, are used to stretch the preform (1) in the axial direction, and optionally also in the radial direction. Unlike the bottles obtained by conventional injection blow-moulding, the bottles obtained by injection stretch blow-moulding are significantly longer than the preform (1). Polyethylene terephthalate (PET), polypropylene, high density polyethylene (HDPE), and polyethylene naphthalate (PEN) are non-limiting examples of suitable materials for injection stretch blow-moulding. More information on injection stretch blow-moulding processes can be obtained from general textbooks, for example “The Wiley Encyclopaedia of Packaging Technology”, Second Edition (1997), published by Wiley-Interscience Publication (in particular see pages 87-89).

Unless otherwise stated, the term “injection blow-moulding” is used hereinafter to designate both “injection blow-moulding” and “injection stretch blow-moulding” processes.

In extrusion blow-moulding, the molten plastic is extruded (typically continuously) to form an open-ended continuous tube (a “parison”). The extruded plastic is cut at regular intervals and the cuts are directly blow-moulded to form an article. In the extrusion blow-moulding process, the molten plastic material is typically not first formed into a preform. The final shape of an article produced by extrusion blow-moulding is less precise and less controllable than those obtained by injection blow-moulding. Further details on extrusion blow-moulding can be obtained in general packaging textbook, for example in “The Wiley Encyclopaedia of Packaging Technology”, referred to above (in particular pages 83-86). Extrusion blow-moulding may be used to obtain laminated or co-extruded bottles with multiple layers for aesthetic or improved physical (barrier) properties.

The resulting blown container (10) typically has a neck (40), having the same finish with outer threads and lowermost neck flange as the neck (4) of the preform (1). The remainder of the bottle undergoes expansion, although to varying degrees, until the container (10) is formed and ejected from the mould.

### Test Methods:

### A) Weight Average Flake Diameter of the Pearlescent Agent:

The weight average flake diameter of the pearlescent agent, including mica pearlescent agents, is determined by classifying the pearlescent agent with micro-sieves and sieves having various openings, and plot the result on Rosin-Rammlar chart.

The following sieve sizes should be used to classify pearlescent agent: 1000, 600, 425, and 300 microns, in combination with the following micro-sieve sizes: 212, 150, 106, 75, 53, 45, and 38 microns.

Read from the chart the opening, l₅₀, of the micro-sieve or sieve passing 50% of the total weight of the powder. Then, the weight average flake diameter, l, is defined by the formula (1) or (2):

l=l₅₀(in the case of micro-sieve) (1)

l=√(150)(in the case of sieve) (2)

The weight average aspect ratio, α, of the pearlescent agent, means a value calculated from the weight average flake diameter, l, and the weight average flake thickness, d, of the inorganic powder, determined by a method given below, from the formula (3):

α=l/d (3)

The weight average flake thickness, d, is calculated by formula (4), using the method disclosed in the paper “Particle Size Measurement by a Powder Film Method” by C. E. Capes and R. C. Coleman, {Ind. Eng. Chem. Fundam., Vol. 12, No. 1, p. 124-126 (1973)}. In the paper, the mean particle size is determined by measuring the area of a mono-particulate film of the pearlescent agent spread on a liquid surface, A:

$$d = \frac{M}{ρ ( 1 - ɛ ) \cdot A} \times {10}^{4} μ \qquad ( 4 )$$

wherein M is the mass of the pearlescent agent particles (in grams), ρ is the true particle density of the pearlescent agent (in g per cubic centimetre), and (1−ε) is the fractional area covered by the particulates in the film, which is typically 0.9 for mica powder under the cited experimental conditions.

### B) Measuring Lightness, L:

The lightness L, on the DE CMC scale, can be measured by cutting out a piece of the container, covering at least the sensor aperture. If needed, the test sample can be flattened using an iron at a temperature between the softening point of the container layers, and the melt point. The iron temperature must not be so high as to cause discoloration of the test sample.

The sample is then mounted into an X-Rite SP64 sphere diffuse/D8 spectrophotometer, with the X-Rite DRS 80 bench-top stand, which has been calibrated according to the manual. The measurement is taken using the following settings:
UV Filter: Out/UV Inc
Port size: 8 mm
dE_CMC limit: 0.5
Illuminant: D65
Observer angle: 10°
L:C ratio: 1.4:1
Colour system: CIE L*a*b*
Specular condition: Included
R/T mode: Reflectance
Tolerancing: CMC tolerancing

For samples having a transmittance of greater than 20%, the spectrophotometer is set to “Over light/Over dark”, and a standard white backing material is positioned directly behind the sample.

For samples having a transmittance of less than 20%, the spectrophotometer is set to Specular Included-Normal (Single mode).

### EXAMPLES

### Example 1

the first layer of the preform was formed using a first thermoplastic resin comprising PET grade Ramapet® 9921W (Indorama) and 2.5 wt % of Colormatrix 281-2039-3 pearlescent agent. The first layer was over-moulded with a second thermoplastic resin comprising PET grade Ramapet® 9921W (Indorama) and 0.37 wt % of Colormatrix 265-10338-3 blue dye. The resultant preform had a weight of 45.5 g. The neck of the preform in this example was made of the second thermoplastic resin, and also comprised the colorant.

The preform was heated in a standard ISBM reheat oven (part of the Sidel ISBM Universal machine) and then stretch blow moulded to form an opaque, high gloss, container. The resultant container also comprised two layers. The container comprised a first layer comprising the pearlescent agent, and a coloured second layer having a vivid blue colour.

### Example 2 (Comparative)

A container was made using the same method as the container of example 1, except that both the pearlescent agent and the blue dye were added to the first layer. The second layer contained no pearlescent agent and no dye, and was fully transparent. The total amount of both the pearlescent agent and blue dye was kept the same as in the container of example 1.

### Example 3 (Comparative)

A container was made using the same method as for the container of example 1, except that both the first layer and the second layer contained the pearlescent agent and the blue dye. Thus, a mono-layer container was made, using the same process as used to make the container of example 1. The total amount of both the pearlescent agent and blue dye was kept the same as in the container of example 1, and was added at the same concentration to both the first layer and second layer.

TABLE 1
For the containers of examples 1 to 3, the gloss level, lightness L, and
blueness b, is given below. On the DE CMC scale, a more negative
b denotes a more vivid blue bottle.

| | | | Gloss | | Blue |
|---|---|---|---|---|---|
| | | | level | Lightness | level |
| | First layer | Second layer | (GU)⁽¹⁾ | (L)⁽²⁾ | (b)⁽²⁾ |
| Example 1 | Colormatrix | Colormatrix | 103 | 45.8 | −21.5 |
| | 281-2039-3 | 265-10338-3 | | | |
| | pearlescent agent | blue dye | | | |
| Example 2 | Colormatrix | — | 110 | 56.7 | −11.3 |
| | 281-2039-3 | | | | |
| | pearlescent | | | | |
| | agent | | | | |
| | and | | | | |
| | Colormatrix | | | | |
| | 265-10338-3 | | | | |
| | blue dye | | | | |
| Example 3 | Colormatrix | Colormatrix | 9 | 59.1 | −13.6 |
| | 281-2039-3 | 281-2039-3 | | | |
| | pearlescent | pearlescent | | | |
| | agent and | agent and | | | |
| | Colormatrix | Colormatrix | | | |
| | 265-10338-3 | 265-10338-3 | | | |
| | blue dye | blue dye | | | |

⁽¹⁾as measured using an Erichson Picogloss 503 measurement device with a 20° measurement angle
⁽²⁾as measured on the DE CMC scale, using the X-Rite SP64 sphere diffuse/D8 spectrophotometer

As can be seen in Table 1, the container of the invention (example 1) has a gloss level which is comparative to that of a two layer bottle, having both the pearlescent agent and colorant in the first layer. In addition, for the same add-on level of the pearlescent agent and colorant, a significantly more vivid blue is achieved, with only a small loss in lightness.

The container of the present invention (example 1), provides a much greater level of gloss, in comparison to a monolayer bottle, having the same add-on level of pearlescent agent and colorant. In addition, for the same add-on level of the pearlescent agent and colorant, a significantly more vivid blue is achieved, with only a small loss in lightness.

### Example 4

the first layer of the preform was formed using a first thermoplastic resin comprising PET grade Ramapet® 9921W (Indorama) and 2.5 wt % of Colormatrix 281-2039-3 pearlescent agent. The first layer was over-moulded with a second thermoplastic resin comprising PET grade Ramapet® 9921W (Indorama) and 0.69 wt % of Colormatrix 269-10295-1 yellow dye. The resultant preform had a weight of 45.5 g. The neck of the preform in this example was made of the second thermoplastic resin, and also comprised the colorant.

The preform was heated in a standard ISBM reheat oven (part of the Sidel ISBM Universal machine) and then stretch blow moulded to form an opaque, high gloss, container. The resultant container also comprised two layers. The container comprised an opaque first layer comprising the pearlescent agent, and a coloured second layer having a yellow colour. The result was a container having a metallic gold effect, even though the container was free of metallic particles.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A preform (1) comprising a first layer (2) and a second layer (3), with the second layer (3) being an outer layer relative to the first layer (2), wherein:
a. the first layer (2) comprises a pearlescent agent; and
b. the second layer (3) is substantially transparent and comprises a colorant.

2. The preform (1) according to claim 1, wherein the pearlescent agent of the first layer (2) has a weight average flake diameter of from about 1 to about 200 microns.

3. The preform (1) according to claim 1, wherein the first layer (2) comprises from about 0.01 to about 10% by weight of the pearlescent agent.

4. The preform (1) according to claim 3, wherein the first layer (2) comprises from about 0.15 to about 1.5% by weight of the pearlescent agent.

5. The preform (1) according to claim 1, wherein the pearlescent agent is selected from the group consisting of: mica, coated mica, titanium dioxide, and mixtures thereof.

6. The preform (1) according to claim 1, wherein the preform (1) is substantially free of metallic particles.

7. The preform (1) according to claim 1, wherein the first layer (2) is substantially opaque.

8. The preform (1) according to claim 1, wherein the colorant of the second layer (3) is a dye.

9. The preform (1) according to claim 1, wherein the first layer (2) comprises a thermoplastic resin selected from the group consisting of: polyethylene, polypropylene, and polyethylene terephthalate, and mixtures thereof.

10. The preform (1) according to claim 1, wherein the second layer (3) comprises a thermoplastic resin selected from the group consisting of: polyethylene, polypropylene, and polyethylene terephthalate, and mixtures thereof.

11. The preform (1) according to claim 1, wherein one or both of the first layer (2) and second layer (3) comprise a renewable thermoplastic resin, the renewable thermoplastic resin being selected from the group consisting of:
(a) a high density polyethylene (HDPE) having a biobased content of at least about 95%;
(b) polyethylene terephthalate (PET), or a polyester of furan dicarboxylic acid, each having a biobased content of at least about 90%;
(c) a polypropylene (PP) having a biobased content of at least about 90%; and
(d) combinations thereof.

12. A container (10), formed from a preform (1) according to claim 1, comprising a container first layer (20) and a container second layer (30).

13. The container (10) according to claim 12, having a gloss level, as measured by ISO 2813, of from about 70 to about 130 GU (Gloss Units).

14. The container (10) according to claim 13, having a gloss level, as measured by ISO 2813, of from about 80 to about 110 GU (Gloss Units).

15. The container (10) according to claim 12, wherein the container (10) has a lightness, L, of at least about 25 when measured at the outer surface of the container.

16. The container (10) according to claim 15, wherein the container (10) has a lightness, L, of at least about 40, when measured at the outer surface of the container.

17. The container (10) according to claim 12, wherein the container second layer (30) is substantially transparent, having a transmittance of from about 20% to about 100%, as measured by ISO 2471.

18. The container (10) according claim 12, wherein the container (10) is substantially opaque, having a transmittance of less that about 15%, as measured by ISO 2471.

19. The container (10) according to claim 18, wherein the container (10) is substantially opaque, having a transmittance of less that about 5%, as measured by ISO 2471.

20. The container (10) according to claim 12, wherein the colorant of the container second layer (30) has a yellow or brown colour, and the container is substantially free of metallic particles.
